(19) United States
(12) Patent Application Publication
(10) Pub. No.: US 2006/0013959 A1
(43) Pub. Date: Jan. 19, 2006

(54) Process to apply a polimeric coating on non-ferrous substrates

(76) Inventor: Hector Delgado Morales, Estado de Mexico (MX)

Correspondence Address: Orum & Roth, 53 West Jackson Blvd., Chicago, IL, 60604, US

(21) Appl. No.: 11/109,427

(22) Filed: Apr. 19, 2005

(30) Foreign Application Priority Data
Jul. 15, 2004 (MX) 006868

(51) Int. Cl. B05D 7/00

(52) U.S. Cl. 427/407.1

(57) ABSTRACT

This invention is a method to coat an object or non-ferrous plate with a non-porous polymeric coating that has excellent adherence to the non-ferrous substrate. The process includes the following steps: conditioning or chemically treating a non-ferrous substrate surface; heating the substrate to a temperature above 180° C. but less than the ignition temperature of the plastic coating; applying a first layer of plastic material to the heated surface, immediately applying a second plastic layer onto the first plastic layer which is maintained at a minimum temperature of 180° C.; reheating the two plastic layers at a temperature from 180-280° C., to produce a smooth non-porous surface: and allowing the substrate and plastic coating to cool.

### INVENTION FIELD

This invention describes a technique to coat surfaces by means of a plastic coating. Specifically, this invention describes a process to coat non-ferrous metal surfaces, the composition of the plastic coating used in said process and products that comprise the plastic coating.

### BACKGROUND

Methods currently used for the application of a plastic coating to a substrate are those commonly available in the state-of-the-art, such as powder immersion, fluidized bed or thermoshrinkable film. The main disadvantage of these kinds of methods is that it is difficult to make them work on very different part sizes and the adhesive strength of the plastic coatings to the surface of products made of non-ferrous metals is very low.

There have been many attempts aimed at obtaining plastic coatings with good adhesion and methods to apply the coatings. U.S. Pat. No. 2,983,704 granted to Roedel discloses high and low density polyethylene mixtures. U.S. Pat. No. 3,348,995 granted to Baker discloses a method to coat metallic surfaces with polyethylene by using a polyethylene primer. The method used to coat the metallic surface is a process using two layers with the first layer being high density polyethylene and the second layer medium or low density polyethylene, or a mixture of both of them.

U.S. Pat. No. 3,410,709 granted to Meyer discloses a method to produce a polyethylene coating on a metal by mixing an organic crosslinking agent with powdered polyethylene to improve the bonding to a metallic surface.

U.S. Pat. No. 3,639,189 granted to Hartman disdoses adhesive compositions including polyethylene and oxidized polyethylene, which include an elastomer as an additional component in the mixture. U.S. Pat. No. 4,007,298 granted to Feehan is related to polyethylene coatings for ferrous metals. This patent describes mixing a high density polyethylene and a low density polyethylene to take advantage of the bonding properties of the high density polyethylene and its flexibility as well as the low cost of the low density polyethylene.

U.S. Pat. No. 4,182,782 granted to Scheiber, describes a method to coat the external surface of a metallic pipe wherein the process consist of coating a pipe with powdered plastic using a fluidized bed. U.S. Pat. Nos. 4,211,595 and 4,213,485 granted to Samour, disdose a method of first coating a pipe with epoxy or some other coating and then extruding an external layer of polyethylene or other plastic over the first coat. U.S. Pat. No. 4,307,133 granted to Haselier, describes a method of applying a polymeric coating on a metallic surface and the appropriate polymeric powder for this method. This patent describes the use of a stabilized or un-stabilized polyolefin powder mixture to coat a hot metallic surface. U.S. Pat. No. 4,319,610 granted to Eckner, describes coating metallic pipes and the use of the coated pipes. This patent describes the process of coating tubes or pipes by using specific temperatures and melt indexes of plastic. U.S. Pat. No. 4,865,882 granted to Okano, disdoses a method of powder coating metallic articles wherein the polypropylene is used as a primary coating with polyethylene added as part of the coating. U.S. Pat. No. 4,910,046 granted to Herwig, describes formulations of resins for powder coating metallic parts using a modified low density polyethylene and other components. U.S. Pat. No. 4,921,588 granted to Johnson, is related to the use of polyethylene as additive for other plastic to prevent cracking. U.S. Pat. No. 4,923,550 titled “Method of Making Wear Resistant Composites”, describes the use of an elastomer between the polyethylene and the metallic substrate for improved bonding. U.S. Pat. No. 5,750,252 titled “Protective Coating for Metal Surfaces” describes the bonding of a modified polyethylene film to metallic substrate with a second layer joined to the first one.

However, none of the efforts of the state-of-the-art have been aimed at solving the problem of adhering a uniform plastic layer without joints to the non-ferrous metal surface, wherein the adhesive bond of the plastic coating is almost impossible to detach. In addition, there is a need for a tough, abrasion resistant, non-racking plastic that is one hundred percent safe for food contact. There is also a need for a non-slip polyethylene coating which will not degrade upon contact with acid or water, and in addition will take temperatures of up to 110° C. With the addition of additives or by using of other plastic resins, higher temperatures are possible, without comprising other physical properties. Finally, there is the need for a plastic coating that can be applied to a flat substrate to produce a fully flexible product which can be bent into any shape.

Taking into consideration the defects of the above stated state-of-the-art, it is the purpose hereof to provide a simple process to coat non-ferrous metal surfaces, with the additional ability to efficiently coat very different part sizes.

Another purpose of this invention is to provide a process to coat non-ferrous metallic surfaces, wherein the plastic coating layer is bonded to the nonferrous metallic surface, in such a way that it is almost impossible to detach.

One more purpose of this invention is to provide a plastic coating composition that can be applied as a layer to non-ferrous metal surfaces wherein the plastic coating layer is tough, abrasion resistant and non-cracking, and is one hundred percent safe for food contact.

Another purpose of this invention is to provide a polyethylene plastic coating that has non-slip properties, and that will not degrade upon contact with acid or water, is resistant to temperatures of up to 110° C., or is resistant to higher temperatures with the addition of additives or the use of other plastic resins without compromising other physical properties.

Finally, this invention is also meant to provide a plastic coating that can be applied to a flat substrate to produce a fully flexible product which can be bent into any shape.

### BRIEF DESCRIPTION OF THE INVENTION

This invention describes a process for applying plastic coatings with excellent adhesive bonding properties on non-ferrous metals which comprise the following steps: providing a non-ferrous substrate; conditioning or chemically treating the substrate surface to be coated; heating the substrate to a temperature above 180° C. but less than the ignition temperature of the plastic coating; applying a first layer of plastic material to the heated surface, wherein the first layer consists in a mixture of ground polyethylene that has a particle size of 20 mesh or less, a density between 0.91 and 0.965 g/cm³ and a melt index between 0.5 and 50 g/10 minutes; immediately applying a second plastic layer onto the first plastic layer which is maintained at a minimum temperature of 180° C., wherein the second layer consists of a mixture of ground polyethylene that has a partide size of 20 mesh or less, a density between 0.91 and 0.965 g/cm³ and a melt index between 0.5 and 50 g/10 minutes; reheating the two plastic layers at a temperature from 180-280° C., to produce a smooth non-porous surface; and allowing the substrate and plastic coating to cool.

This invention also describes a plastic coating and a product comprising said plastic coating.

### DETAILED DESCRIPTION OF THE INVENTION

The purpose of this invention is to coat non-ferrous surfaces regardless their shape, providing a surface with a plastic coating and improved characteristics. The method of this invention produces an attractive surface, very resistant to chemical agents, abrasion resistant, stain resistant, deanable, strong and flexible. If the coating is applied to a flexible substrate, the coating is capable of being flexed without breaking, cracking or delaminating. In addition, the coating is light and has good insulating properties.

Non-ferrous substrates that can be used to apply a plastic coating with a high adhesive bond strength using the method of this invention are non-ferrous substrates selected from the group of non-ferrous metals, aluminum and its alloys and copper, zinc, lead, silver and their alloys. The non-ferrous substrates especially preferred by this invention are non-ferrous substrates selected from the group of aluminum, copper and brass.

The plastic coating using the method of this invention applied to a non-ferrous substrate is generally formed by two layers of plastic material. According to the principles of this invention, the first plastic layer is considered the adhesive layer and the second layer of plastic material is considered the work layer.

In a preferred embodiment of the invention, the first layer or adhesive layer of plastic material consists of a polyethylene layer with the addition of an additive producing a foaming action. This first layer may be made of polyethylene having a density range of 0.91 to 0.965 g/cm³ and a melt index in the range of 0.5 to 50 g/10 minutes. A formulation especially preferred and useful for the first layer of plastic material for the coating is polyethylene with a density between 0.937 and 0.939 g/cm³, and a melt index between 1 and 10 g/10 minutes, with the addition of an additive to produce a foaming action.

The literature suggests that the first layer of the plastic coating is composed of high density polyethylene to improve the adhesion to the non-ferrous substrate. The disadvantage of using high density polyethylene is its higher cost. In addition, there is no known advantage of using high density polyethylene instead of this invention to improve on the adhesion to the non-ferrous substrate. The polyethylene is considered high density if it has a density in the range of 0.941 and 0.965 g/cm³. Therefore, the preferred plastic material for the plastic coating of a non-ferrous substrate is a low density polyethylene to provide the best adhesion and lowest cost to said non-ferrous substrate.

According to this invention, the second layer or work layer may be any plastic material having a melt index in the range of 1 to 50 g/10 minutes, which will adhere to the first layer of plastic material (namely, low density polyethylene). Normally, the most common types of plastic material are polyethylene or polypropylene, but other types of plastic materials may be used as long as they adhere properly to the first layer or adhesive layer. In a preferred embodiment, the second layer of plastic material consists of low and high melt index polyethylene, which may be applied separately or in a mixture. A mixture for the second layer or work layer may comprise a polyethylene with a melt index of 3-5 g/10 minutes and a polyethylene with a melt index of 20-30 g/10 minutes. This preferred combination of polyethylene allows a mixture of different colored plastic grains in the coating to remain intact and not bleed to create a distinct stone like surface. This preferred mixture for the second layer of plastic material is mainly used for decorative reasons, although the use of only polyethylene with a fusion index of 20 to 30 g/10 minutes provides some desirable superficial characteristics such as a smoother surface and a more consistent color.

The plastic used for the first and second layers of coating could be filled with compounds or additives to improve the physical properties, visual and esthetic characteristics of the plastic coating.

Another important factor of the process to apply a plastic coating on non-ferrous metals is that the plastic materials used for the first and second layer must be crushed or ground. The ground plastic material must have a partide size of 200-400 mesh. The ground plastic material serves several purposes: 1) to allow the plastic material to be quickly and uniformly melted; 2) the small partides allow different colors to be mixed together and when melted they are dispersed in a visually pleasing way; and 3) to reduce the partide size of the high melt index component. The high melt index plastic is relatively smooth and it tends stain more hence reducing the partide size reduces the impact of staining on the surface. The preferred partide size for the products is 80-100 mesh or less. For other types of products, the 20-30 mesh and smaller plastic would be perfectly acceptable.

The process of this invention to apply a plastic coating to a non-ferrous substrate includes a conditioning step for the substrate surface, where said coating is to be applied to provide an adhesive base for the first layer of plastic coating. The surface conditioning step consists of a conditioning or chemical conditioning in which the non-ferrous substrate surface is subjected to the action of a suitable chemical agent. The suitable chemical agent used for the chemical treatment is selected from the following group: an acid solution of one or more of the following acids: phosphoric acid, acetic acid, muriatic acid, nitric acid, tannic acid and/or hydrochloric acid; or a caustic solution selected from the following group: caustic soda, any other strong base, or a mixture of bases. In a preferred embodiment of the invention, the concentration of the acid solution may vary in proportion of 1 part of acid by one part of water to a dilution of 1 part of acid by 20 parts of water.

The conditioning time or chemical treatment of the non-ferrous substrate with the chemical agent (for example, an acid solution) depends on the concentration of the acid solution and the temperature thereof. As the temperature of the acid solution increases, the reactivity of the acid increases, too. Generally, in the process of this invention, the temperature of the acid solution has not been held constant, which has a significant impact on the reactivity of the acid for any given concentration.

The chemical conditioning stage must produce a uniform condition on the entire surface of the plate. In the heating stage, the treated substrate is heated to a temperature above 180° C., but lower than the temperature at which the plastic coating material would self ignite.

The conditioned and heated non-ferrous substrate is then subject to the first coating stage in which a first layer of plastic material is applied to said substrate. Any suitable method in the state-of-the-art may be used for the application of the first coat of plastic to the substrate surface, such as for example, sprinkling or curtain coating, standard rotomolding techniques, fluidized bed, electrostatic spraying, fluidized powder spreader, scatter powder coater, covering the surface of the object with excess plastic powder, for a specified time and then removing the excess, or alternatively, by mixing the plastic powder with a solvent and applying it like a paste.

In a preferred embodiment of this invention process, the first layer of plastic material is applied to the treated and hot substrate as a thin layer using any of the above-mentioned methods. While the first layer of plastic material is still hot and in a molten state, a second layer of plastic material is immediately applied. Generally, the second layer of plastic coating is applied as a powdered or ground plastic material, using any of the above described methods. Alternatively, the second layer of plastic material may be applied as an extended film, wherein the film may be applied by either wrapping a tube shaped substrate or by applying to a sheet or flat substrate.

The temperature of the non-ferrous substrate must be maintained at all times during the first and second stages of coating until all the applied plastic material of the first and second layers is uniformly melted In an alternate embodiment, the treated non-ferrous substrate may be pre-heated if both sides of the object are to be coated or it may be heated from the uncoated side to maintain a minimum temperature of 180° C. In the case that the object to be coated has enough thermal mass to fully melt the plastic material, then the object may only be pre-heated and the first and second layers of plastic material applied, without heating the object again. On the contrary, if the object does not have sufficient thermal mass to totally melt the first and second layer of applied plastic material, then the object should be heated after the first and second layers of plastic material are applied. In the case that the object to be coated is flat or sheet, the heat must be applied to the uncoated side of the substrate.

The thickness of the applied plastic coating is generally determined by the amount of plastic material applied to the surface of the non-errous substrate. For example, when the sprinkling or curtain coating method is used, the thickness must be controlled by keeping the substrate at a steady temperature and maintaining the cascading flow of the powder plastic material constant on said object for certain period of time while the object is rotated under the plastic material cascade flow. This method will produce a reasonably uniform coating thickness because as the coating thickness increases it begins to act as an insulator reducing the surface temperature of the surface, which in turn begins to limit the amount of plastic material that adheres to the surface. Since the object remains under the cascading powder for only 15 seconds, the thicker sections that could hold more heat do not necessarily create a thicker plastic coating.

In another example, the rotomolding technique could be used to apply a plastic coating of this invention to the internal of a vessel or object. A specific amount of powder plastic material would be introduced to the internal portion of the vessel or object as it is turned. The powder plastic material would be uniformly distributed by means of the movement of the object and would produce a plastic coating with a uniform surface. In another example of the invention, when using the fluidized bed process the object is introduced to the fluidized bed at a specific temperature. The time of exposure in the bed determines the thickness of the plastic coating. When an electrostatic spraying method is used to apply the plastic coating of the invention, a relatively thin but very uniform plastic coating would be produced The methods of fluidized powder spreading and the scatter powder coater are very similar, but they require that the object to be coated is flat. The powder plastic coating would be uniformly deposited on the uniformly moving plate surface, resulting in a uniform coating thickness.

Another option is to apply excess plastic material on to the surface to be coated and then remove said excess after a specific period of time.

Regardless the method used apply the plastic coating of this invention, generally the second layer of plastic coating material will be applied in different thickness that may be as thick as 0.635 cm (0.25 inches).

After the first and second layers of plastic material have been applied, this process comprises an additional stage. The coated side of the sheet or object is subjected to a heat source to remelt and smooth out the surface of the plastic coating. For said purpose, the coated surface is heated up to a temperature between 180 to 280° C. until a smooth and even surface is produced. Finally, the object or sheet is then uniformly cooled.

The invention will be illustrated now by means of the following examples, which are provided for illustration purposes. The examples should not be considered as limiting the scope of the invention.

### EXAMPLES

### Example 1

In the embodiment of this invention, the surface of an aluminum object (for example, bowl, plate, jar, vase, etc.) is subject to treatment by chemical conditioning using a hydrochloric acid and water solution until the surface of the object is uniformly conditioned.

For the coating stage of this invention process, a polyethylene plastic was used for the first and second layers of the plastic coating. The plastic was crushed or ground to a particle size of 80-100 mesh. The primary coating is formed by polyethylene with a melt index of 4.0 g/10 minutes and a density of 0.938 g/cm³ with the addition of an additive that produces a foaming action. After the chemical treatment, the treated surface of the object is heated to 180° C. to 300° C. After uniformly heating the treated surface of the object, the first layer of plastic material is applied. This first layer is applied by pouring the mixture of powdered polyethylene over the heated surface until it a thin uniform first layer of coating is applied. Then, the second layer of plastic material is immediately applied pouring the second powder mixture over the first layer. The coating thickness formed by the first and second layer is controlled by means of the time the object is subjected to the powdered plastic. Then, the object is allowed to stand without additional heating until the plastic surface is fully melted. After the temperature of the coated surface drops to approximately 120° C., the coated surfaces are subject to a heat source with a temperature of 180 to 280° C. This heat source remelts the plastic coating surface to create a smooth and even coated surface. The coated surface of the object is cooled at room temperature.

### Example 2

In another embodiment of this invention, the surface of an aluminum plate is subject to treatment by chemical conditioning using an acid solution until the plate surface is uniformly conditioned.

For the coating stage of this invention process, polyethylene plastic was used for the first and second layer of the plastic coating The plastic was crushed or ground to a particle size of 80-100 mesh or less. The basic coating is formed by polyethylene with a melt index of 4.0 g/10 minutes and a density of 0.938 g/cm³, with the addition of an additive producing a foaming action. The second layer of plastic coating consists of a mixture of 1:1 of colored polyethylene with a melt index of 4.0 g/10 minutes and a density of 0.938 g/cm³ and a natural polyethylene with a melt index of 25 g/10 minutes and a density of 0.917 g/cm³. After the chemical conditioning, the treated surface of the aluminum plate is heated to 180° C. to 300° C. After uniformly heating the treated surface of the plate, the first layer of plastic material is applied. This first layer is applied by pouring the powdered polyethylene mixture onto the treated surface of the aluminum plate until a thin uniform layer of coating covers the surface. Then, the second layer of plastic material is immediately applied placing a thick layer of the second powder mixture on top of the first layer. Then the uncoated surface of the plate is heated for 5 seconds. The excess plastic powder is then removed from the surface. The coating thickness was controlled by controlling the time that the plastic material remained on the heated surface of the plate and by the aluminum plate temperature. The aluminum plate with the coating was then subject to an additional heat source (220 to 300° C.) until the surface plastic was completely melted. When the coating was slightly gelled, the coated surface was subjected to a heat source to remelt the plastic surface. A temperature of 180 to 280° C. was used to create a smooth and even surface. The coated plate was cooled at room temperature.

### Example 3

Example 3 is similar to Example 1, except that a 30 mesh and a smaller ground plastic was used for the two plastic layers.

### Example 4

Example 4 is similar to Example 2, except that 30 mesh and a smaller ground plastic was used for the two plastic layers.

### Example 5

Example 5 is similar to Example 2, except that the second plastic material layer was poured over the inclined surface of the sheet for a period of 30 seconds.

### Example 6

Example 6 is similar to Example 1 and Example 2, except that instead of the second layer being composed of one part of plastic with a melt index of 25 g/10 minutes and one part of plastic with a melt index of 4g/10 minutes the second layer was composed of one part plastic with a melt index of 25 g/10 minutes and three parts of a plastic with a melt index of 4 g/10 minutes.

### Example 7

Example 7 is similar to Example 1 and Example 2, except that the second plastic layer consists only of plastic with a melt index of 4 g/10 minutes.

### Example 8

Example 8 is similar to Example 1 and Example 2, except that the second plastic consists only of plastic with a melt index of 25 g/10 minutes.

### BONDING TESTS

The samples that were provided for tensile testing were built as described in Example 1 above. These samples consisted of a cast aluminum substrate with the first and second layers of polyethylene. A special test coupon was manufactured by attaching a stud to a 2.54 cm×2.54 cm square of aluminum. This special test coupon and a flat piece of aluminum were conditioned in acid. The two parts were placed flat surface to flat surface and coated with plastic. The assembly was subjected to a tensile load with the load exceeding 475 psi.

The other bonding test used consists of pushing a single edged razor blade between the plastic and the substrate in the interface of the two materials. If the joint is poor, the plastic coating will be easily separated from the substrate. The results obtained did not produce failures in any of the chemically conditioned surfaces.

Although the invention has been described in relation to the specific embodiments hereof, it is understood that additional modifications of this invention are possible and this application is aimed at protecting any of the variations, uses or adaptations of the invention that generally follow the invention principles. This includes the variations of this disclosure as they occur in the known and used practice of the state-of-the-art to which the invention corresponds, how the variations may be applied to the essential characteristics previously established and how they are within the scope of the enclosed claims.

1. A process for coating a non-ferrous substrate with a non-porous polymeric substrate that has excellent adherence to the substrate, where it comprises the following steps:
a) conditioning or chemically treating the non-ferrous substrate surface to be coated;
b) heating the non-ferrous substrate treated to a temperature above 180° C. but lower than the ignition temperature of the polymeric coating;
c) applying a first coat to the hot treated surface of the substrate wherein the first coat is made up of powdered polyethylene that has a partide size of 20 mesh or less, a melt index of 0.5 to 50 g/10 minutes and a density of 0.910 and 0.939 g/cm³, and an additive that produces a foaming action;
d) applying a second coat onto the first coat while the substrate temperature is maintained at a minimum of 180° C., wherein the second coat is made up of powdered polyethylene that has a particle size of 20 mesh or less;
e) reheating said coating formed by the first and second polymeric material coats to a temperature of 180 to 280° C., to produce a smooth non-porous surface; and
f) cooling the substrate coated with the first and second polymeric material coats.

2. The process to coat a non-ferrous substrate with a non-porous polymeric coating, according to claim 1, where the substrate is selected from the following group of non-ferrous metals, aluminum, and its alloys and copper, zinc, lead, silver and their alloys.

3. The process to coat a non-ferrous substrate with a non-porous polymeric coating, according to claim 1, where the substrate is a cast non-ferrous metallic object or a non-ferrous metallic object formed by another method, for example, forged, stamped, or spun.

4. The process to coat a non-ferrous substrate with a non-porous polymeric coating, according to claim 1, where the substrate is a sheet or plate material or a fabrication of sheet or plate.

5. The process to coat a non-ferrous substrate with a non-porous polymeric coating, according to claim 1, where the substrate is pipe, wrought bar or an extrusion.

6. The process to coat a non-ferrous substrate with a non-porous polymeric coating, according to claim 1, where the second coating is a single polymer such as the polyethylene, polypropylene, nylon or any other compatible polymer.

7. The process of coating a non-ferrous substrate with a non-porous polymeric coating, according to claim 1, where the second coating is a mixture of different compatible polymers, such as a polyethylene and polypropylene mixture, or polyethylene and nylon.

8. The process of coating a non-ferrous substrate with a non-porous polymeric coating, according to claim 1, where the second coating is a mixture of polyethylene with different melt indexes and densities with the purpose of creating a specific surface appearance.

9. The process of coating a non-ferrous substrate with a non-porous polymeric coating, according to claim 1, where the second coat is an extruded film of the polymer applied to a surface while the first coat is still molten.

10. The process of coating a non-ferrous substrate with a non-porous polymeric coating, according to claim 1, where the first coat consists of:
20 mesh or smaller powdered polyethylene with, a melt index of 0.5 to 50 g/10 minutes, a density of 0.910 and 0.965 g/cm³, and an additive that produces a foaming action.

11. The process of coating a non-ferrous substrate with a non-porous polymeric coating, according to claim 10, where the substrate is selected from the following group of non-ferrous metals; aluminum and its alloys and copper, zinc, lead, silver and their alloys.

12. The process of coating a non-ferrous substrate with a non-porous polymeric coat, according to claim 10, where the substrate is a cast nonferrous metallic object or a non-ferrous metallic object formed by another method, for example, forged, stamped or spun.

13. The process of coating a non-ferrous substrate with a non-porous polymeric coating, according to claim 10, where the substrate is sheet or plate material or a fabrication of sheet or plate.

14. The process of coating a non-ferrous substrate with a nonporous polymeric coating, according to claim 10, where the substrate is pipe, wrought bar or an extrusion.

15. The process of coating a non-ferrous substrate with a non-porous polymeric coating, according to claim 10, where the second coating is a single polymer such as polyethylene, polypropylene, nylon or any other compatible polymer.

16. The process of coating a non-ferrous substrate with a non-porous polymeric coating, according to claim 10, where the second coat is a mixture of different compatible polymers, such as a mixture of polyethylene and polypropylene or polyethylene and nylon.

17. The process of coating a nonferrous substrate with a non-porous polymeric coat, according to claim 10, where the second coating is a mixture of polyethylene with different melt indexes and densities with the purpose of creating a specific surface appearance.

18. The process of coating a non-ferrous substrate with a non-porous polymeric coating, according to claim 10, where the second coat is an extruded film of the polymer applied to the surface while the first coat is still molten.
